(19) United States
(12) Patent Application Publication
(10) Pub. No.: US 2020/0292339 A1
(43) Pub. Date: Sep. 17, 2020

(54) MOVING ASSIST DEVICE AND MOVING ASSIST SYSTEM

(71) Applicant: Honda Motor Co.,Ltd., Tokyo (JP)

(72) Inventors: Masayo ARAI, Saitama (JP); Takamasa KOSHIZEN, Saitama (JP)

(73) Assignee: Honda Motor Co.,Ltd., Tokyo (JP)

(21) Appl. No.: 16/813,752

(22) Filed: Mar. 10, 2020

(30) Foreign Application Priority Data
Mar. 11, 2019 (JP) 2019-044258

(51) Int. Cl. G01C 21/34; G06N 5/04; G01C 21/36; G06Q 10/02

(52) U.S. Cl. CPC G01C 21/3461; G06N 5/04; G06Q 10/02; G01C 21/3682; G01C 21/36

(57) ABSTRACT

A moving assist device and a moving assist system are provided. The moving assist device includes: a route calculation unit that calculates a route from a place of departure to a destination; a route evaluation unit that evaluates the route on the basis of barriers included in the route; and a map generation unit that generates an assist map obtained by displaying a recommended route based on the evaluation on a map, the route being a composite route that includes a parking lot as an intermediate point and includes a vehicle route that indicates moving using a vehicle and a wheelchair route that indicates moving using a wheelchair, the barriers including parking lot barriers related to the parking lot and road barriers related to the wheelchair route, and the route evaluation unit evaluating the composite route on the basis of the parking lot barriers and the road barriers.

### CROSS REFERENCE TO RELATED APPLICATIONS

This application claims the priority benefit of Japanese Patent Application No. 2019-044258, filed on Mar. 11, 2019. The entirety of the above-mentioned patent application is hereby incorporated by reference herein and made a part of this specification.

### BACKGROUND

### Technical Field

The present disclosure relates to a moving assist device and a moving assist system, and particularly to a method for assisting a wheelchair user to move.

### Description of Related Art

Objects that are not obstacles for pedestrians to pass may become obstacles for wheelchair users to pass (hereinafter, referred to as “barriers”). These barriers include, for example, level differences, inclinations, uneven road surfaces, and the like.

In the related art, a technology of automatically collecting barrier information from a low-speed traveling vehicle (a wheelchair, for example) and associating the collected barrier information with map information is known (see Patent Document 1, i.e., Japanese Patent Laid-Open No. 2010-020702). Also, a technology of collecting movement information (positions, time, speeds, and the like, for example) from a mobile terminal along with attributes (whether or not a wheelchair is being used, for example) in regard to map creation and creating a map for a desired purpose on the basis of the collected information is known (see Patent Document 2, i.e., Japanese Patent Laid-Open No. 2013-088500).

Using these technologies enables creation of a map that includes barrier information for a wheelchair user, and using the map enables calculation of a route for avoiding barriers.

However, the technologies in the related art do not assume calculation of routes including transportation (vehicles, for example) other than wheelchairs. Therefore, it is not possible to calculate routes that partially include moving using transportation other than wheelchairs as in a case of moving to a midpoint using a vehicle and then moving from that point to a destination using a wheelchair. Therefore, it is not necessarily possible to state that the technologies in the related art are highly convenient for wheelchair users.

### SUMMARY

The disclosure is made in view of the aforementioned points, and provides a moving assist device and a moving assist system that are highly convenient for wheelchair users.

According to an embodiment of the disclosure, there is provided a moving assist device including: a route calculation unit that calculates a route from a place of departure to a destination; a route evaluation unit that perform an evaluation of the route on a basis of barriers included in the route; and a map generation unit that generates an assist map obtained by displaying a recommended route based on the evaluation on a map, in which the route is a composite route that includes a parking lot as an intermediate point and includes a vehicle route that indicates moving using a vehicle and a wheelchair route that indicates moving using a wheelchair, the barriers include parking lot barriers related to the parking lot and road barriers related to the wheelchair route, and the route evaluation unit evaluates the composite route on a basis of the parking lot barriers and the road barriers.

According to the disclosure, it is possible to improve convenience for wheelchair users.

### BRIEF DESCRIPTION OF THE DRAWINGS

FIG. 1 is an explanatory diagram for a configuration of a moving assist system according to an embodiment of the disclosure.

FIG. 2 is a block diagram of a moving assist device that is included in the moving assist system according to the embodiment of the disclosure.

FIG. 3 illustrates an example of a survey for acquiring user information.

FIG. 4 is a diagram for explaining processing for evaluating a route using the moving assist system according to the embodiment of the disclosure and is an image diagram schematically illustrating a road map.

FIG. 5 illustrates an example of an assist map.

FIG. 6 is an example of a flowchart illustrating operations of the moving assist system according to the embodiment of the disclosure.

### DESCRIPTION OF THE EMBODIMENTS

An embodiment of the disclosure will be described in detail with appropriate reference to drawings. The same reference signs will be applied to the same components, and overlapping description will be omitted.

<Configuration of Moving Assist System>

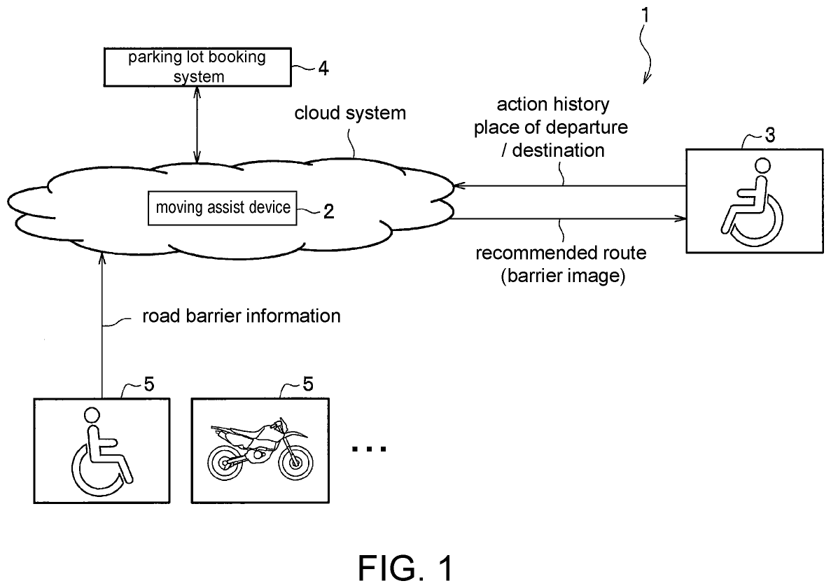

Referring to FIG. 1, a configuration of a moving assist system 1 according to an embodiment will be described. FIG. 1 is an explanatory diagram of the configuration of the moving assist system 1 according to the embodiment.

The moving assist system 1 is a system that assists wheelchair users to move. A moving assist method using the moving assist system 1 belongs to navigation that displays a route suitable for a wheelchair user and a helper among routes to a destination on a map. As moving of the wheelchair user described herein, moving that partially includes moving using transportation (a vehicle, for example) other than a wheelchair in a route is assumed. The moving of the wheelchair user is, for example, moving to a midpoint using a vehicle and then moving from the point to a destination using a wheelchair.

Hereinafter, a person who is involved in moving of the wheelchair user using a service realized by the moving assist system 1 will be referred to as a “user”. The person who is involved in the moving of the wheelchair user is, for example, a driver of a vehicle or a helper of the wheelchair user. Therefore, one person may be the user, or each of a plurality of persons may be the user. In a case in which the wheelchair user himself/herself drives a vehicle, performs an operation of getting in and out of the vehicle, and moves to a destination, for example, the wheelchair user himself/herself is the user. Also, in a case in which a person (for example, a helper) other than the wheelchair user drives a vehicle and helps the operation of getting in and out of the vehicle, and the wheelchair user moves to a destination, for example, each of the wheelchair user and the person who drives the vehicle and the like is a user.

The moving assist system 1 mainly includes a moving assist device 2, a user terminal 3, and a parking lot booking system 4. The moving assist device 2 can mutually communicate with the user terminal 3 and the parking lot booking system 4 via a communication line (a network, for example), which is not illustrated in the drawing. The communication line may be either a wired communication line or a wireless communication line.

The user terminal 3 is a terminal that the user uses. A configuration of the user terminal 3 is not particularly limited as long as it is possible to send a request for presenting a recommended route to the moving assist device 2 and to display the recommended route presented by the moving assist device 2. The user terminal 3 may be, for example, a smartphone, a tablet, a laptop P-type personal computer, or the like. The smartphone is particularly suitable in terms of excellent portability.

The user terminal 3 includes, for example, an input unit that receives inputs of a place of departure and of a destination, a communication unit that transmits the input place of departure and the destination to the moving assist device 2, and a display unit that displays a map that is returned from the moving assist device 2 and includes the recommended route (hereinafter, referred to as an “assist map”) (all the components are not illustrated). The user terminal 3 may include an acquisition unit (for example, a global positioning system (GPS) receiver) that acquires position information and transmit the position information acquired by the acquisition unit as a place of departure to the moving assist device 2.

The parking lot booking system 4 is a system that manages an operating status of a parking lot and ascertains whether or not it is possible to park a vehicle for each parking space, for example. Here, it is assumed that a parking space can be designated and booked.

The moving assist device 2 is a device that provides a service for assisting the wheelchair user to move. The moving assist device 2 may be, for example, an application server and forms a part of a cloud system. An example of the service that the moving assist device 2 provides is to display a route suitable for a user (for example, a wheelchair user) among routes to a destination on a map in response to a request from the user. The route suitable for the user is a route that includes no (or a minimum of) objects and actions that may obstruct moving of the user. Whether or not the objects and the actions obstruct moving may be determined on the basis of a subjective view of the user or may be determined by a third person. In the embodiment, the objects and the actions that obstruct moving of the user will be referred to as “barriers”. The “barriers” described herein include barriers related to a parking lot (hereinafter, particularly referred to as “parking lot barriers”) and barriers related to a wheelchair route (hereinafter, particularly referred to as “road barriers”). The parking lot barriers include, for example, a narrow parking space, no elevator at the parking lot, and the like. The parking lot barriers also include objects and actions that temporarily obstruct the moving of the user depending on time periods. The road barriers include, for example, level differences, inclinations, uneven road surfaces, and the like.

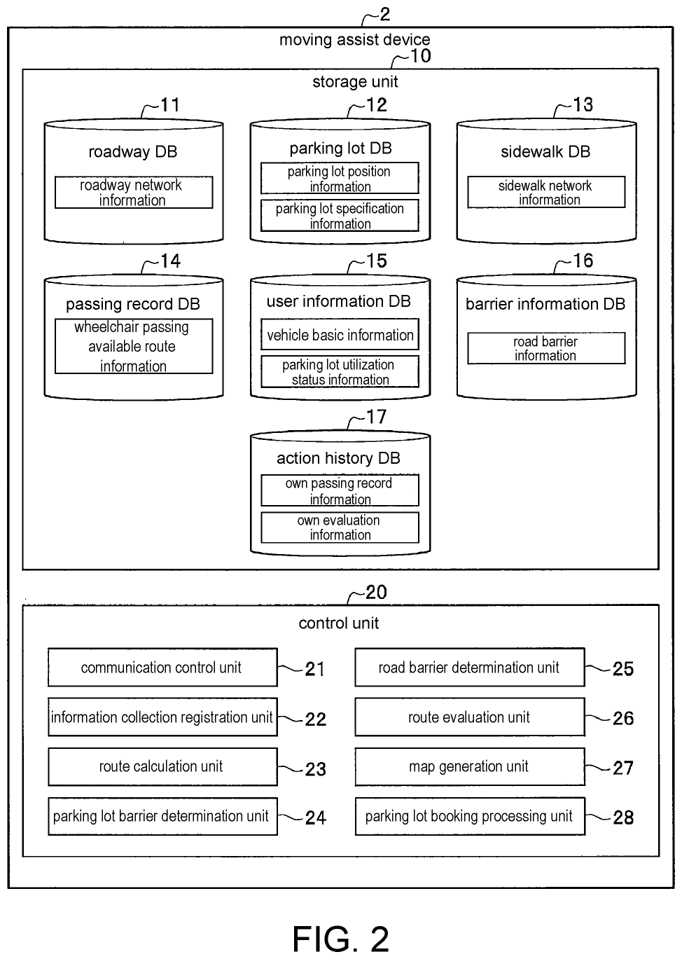

FIG. 2 is a block diagram of the moving assist device 2 according to the embodiment. As illustrated in FIG. 2, the moving assist device 2 includes a storage unit 10 and a control unit 20.

The storage unit 10 is configured of a storage medium such as a random access memory (RAM), a read only memory (ROM), a hard disk drive (HDD), or a flash memory. The storage unit 10 stores various kinds of information used for creating the assist map for assisting the moving of the wheelchair user. The storage unit 10 includes, for example, a roadway DB 11, a parking lot DB 12, a sidewalk DB 13, a passing record DB 14, a user information DB 15, a barrier information DB 16, and an action history DB 17. Note that, a part or an entirety of the information stored in the storage unit 10 may be stored in a location (in another system, for example) other than the moving assist device 2, and the control unit 20 may acquire the part or the entirety of the information via a communication mechanism, which is not illustrated in the drawing, as needed.

The roadway DB 11 stores information related to roads through which the vehicle will pass. The information stored in the roadway DB 11 includes roadway network information in which connection of roadways is represented as data. Note that, roadway networks are information used for calculating a route to a destination.

The parking lot DB 12 stores information related to a parking lot at which the vehicle (here, a four-wheel car, in particular) will be parked. The information stored in the parking lot DB 12 includes information related to position information and a specification of the parking lot (hereinafter, referred to as “parking lot specification information”). The parking lot specification information is, for example, information such as how wide a parking lot and a parking space are, the number of cars that can be parked, the number of parking spaces for wheelchairs (including presence), a height limit in a case of an indoor parking lot, how to park a vehicle, and presence of equipment such as an elevator. Note that, the parking lot DB 12 may further store information related to running of the parking lot (hereinafter, referred to as “parking lot running information”). The parking lot running information is, for example, information related to a running time of equipment such as an elevator.

The sidewalk DB 13 stores information related to roads through which a pedestrian (including the wheelchair user) will pass. The information stored in the sidewalk DB 13 includes sidewalk network information in which connections of sidewalks are represented as data. The sidewalk network information is, for example, “Walking space network data” provided by the Ministry of Land, Infrastructure, Transport and Tourism. Note that, the sidewalk network is information used to calculate a route to a destination.

The passing record DB 14 stores information related to a passing record of the wheelchair user who is the user (including both the wheelchair user himself/herself and another user) in the past. The information stored in the passing record DB 14 includes information related to routes through which the wheelchair user who is a user was able to pass (hereinafter, referred to as “wheelchair passing available route information”).

The user information DB 15 stores information related to the user. The information stored in the user information DB 15 includes information of a vehicle that the user drives (hereinafter, referred to as “vehicle basic information”) and information related to a status when the user uses the parking lot (hereinafter, referred to as “parking lot utilization status information). The vehicle basic information is information of an entire length, an entire height, a lowest height from the ground, a distance between centers of wheels (wheel distance), a weight, and the like of the vehicle, for example. The parking lot utilization status information includes, for example, information related to an operation of getting in and out of the wheelchair (for example, whether or not it is necessary to use a slope), information related to a parking skill of the user (for example, whether or not the user is bad at parallel parking), information related to demands for equipment in and around the parking lot (for example, whether or not it is necessary to use an elevator).

The barrier information DB 16 stores information related to the road barriers (hereinafter, referred to as “road barrier information”). The road barrier information stored in the barrier information DB 16 includes image data obtained by imaging the road barriers, position information (coordinate data) of where the road barriers are present, and vibration information related to vibration generated at the time of passing through the road barriers. An acquisition source of the road barrier information is not particularly limited, and for example, the road barrier information may be collected from a wheelchair passing through the road barriers or may be collected from a vehicle (for example, a motorcycle or a bicycle). There are many roads for which roadways and sidewalks are not provided in a separate manner in Japan, and in that case, wheelchairs and vehicles pass through the same regions. Therefore, the barrier information DB 16 also stores the road barrier information collected from vehicles other than wheelchairs in the embodiment. Note that, the barrier information DB 16 may store information collected from the wheelchairs and information collected from the vehicles other than the wheelchairs such that the information can be divided by associating acquisition sources with road barrier information or the like.

FIG. 1 collectively illustrates subjects that acquire the road barrier information as a “mobile body 5”. The mobile body 5 is, for example, a wheelchair or a vehicle that the user (including both the wheelchair user himself/herself and a person other than the wheelchair user) uses, a vehicle that a person other than the user uses, and the like. Note that, in a case in which road barrier information is collected from the vehicle that the person other than the user uses, the moving assist device 2 may collect road barrier information acquired by the mobile body 5 via another system, which is not illustrated. The mobile body 5 includes, for example, a camera, a global positioning system (GPS) receiver, a vibration sensor, and a communication mechanism. These devices may be mounted in the vehicle, which is the mobile body 5, or a mobile terminal (for example, a smartphone, a tablet, or the like) owned by a driver, which is not illustrated, may have these functions.

The action history DB 17 stores information related to past actions of each user. The information stored in the action history DB 17 includes information related to records that the user himself/herself actually selected and passed through a route among recommended routes presented by the moving assist device 2 (hereinafter, referred to as “own passing record information”) and information related to evaluation on the route when the user actually passed through the route (hereinafter, referred to as “own evaluation information”).

The control unit 20 illustrated in FIG. 2 is realized by a central processing unit (CPU) performing processing of executing a program, a dedicated circuit, or the like. In a case in which the control unit 20 is realized by a program, the program can be stored and provided in a computer-readable recording medium (for example, a CD-ROM). Also, the program can also be provided through a network such as the Internet.

The control unit 20 includes a communication control unit 21, an information collection registration unit 22, a route calculation unit 23, a parking lot barrier determination unit 24, a road barrier determination unit 25, a route evaluation unit 26, a map generation unit 27, and a parking lot booking processing unit 28.

The communication control unit 21 is, for example, a communication interface, and the moving assist device 2 communicates with other devices (for example, the user terminal 3, the parking lot booking system 4, the mobile body 5, and the like) via a communication line (including wireless and wired communication lines), which is not illustrated.

The information collection registration unit 22 collects various kinds of information from the user terminal 3 and the mobile body 5 that are communicatively connected to the moving assist device 2 and registers the collected information in the storage unit 10. Hereinafter, an example of information collection performed by the information collection registration unit 22 will be described.

For example, the information collection registration unit 22 collects information related to the past passing record from the user and registers the collected information in the passing record DB 14. Also, the information collection registration unit 22 collects the road barrier information from the mobile body 5 and stores the collected road barrier information in the barrier information DB 16. In addition, the information collection registration unit 22 acquires user information related to the user and registers the acquired information in the user information DB 15. Also, the information collection registration unit 22 collects routes through which the user actually passed and evaluation of the routes at that time and registers the collected information in the action history DB 17.

Here, a mechanism that collects the road barrier information is not particularly limited. For example, the information collection registration unit 22 may collect the road barrier information using deep learning. In this case, the information collection registration unit 22 has an image recognition model for recognizing objects that may be road barriers from images and determines presence of road barriers from movies captured by wheelchairs and vehicles using the image recognition model. In a case in which the information collection registration unit 22 recognizes that there is a road barrier, then the information collection registration unit 22 associates and stores a captured image of the road barrier, position information where the road barrier is located, and vibration information of vibration caused at the time of passing through the road barrier in the barrier information DB 16. The vibration information may indicate degrees of vibration and may be information indicating vibration in a stepwise manner, for example.

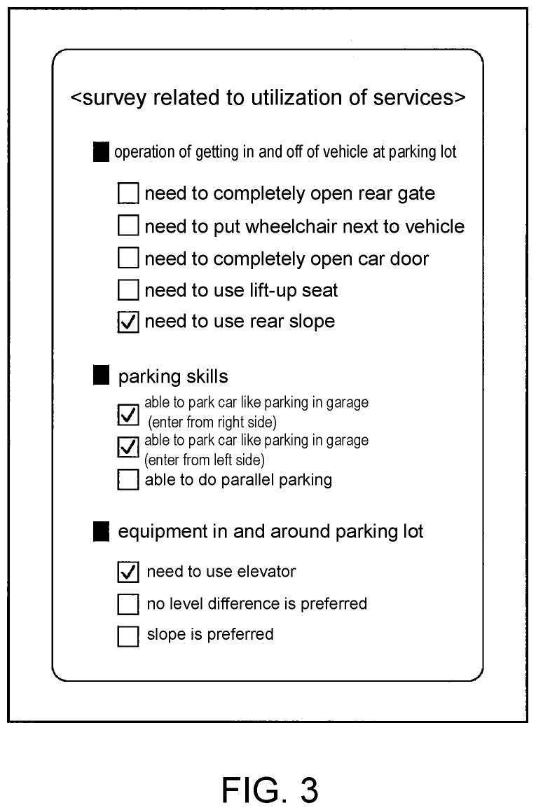

Also, a mechanism that collects the user information is not particularly limited. The collection of the user information is performed at least once for each user. For example, the information collection registration unit 22 receives an input of information (for example, a car model and a grade) for specifying a vehicle, and acquires vehicle basic information from a system or the like that an automobile manufacturer manages using the input information as a key. Also, the information collection registration unit 22 may ask the user to answer user information (particularly, parking-related information) in the form of a survey. An example of a survey for acquiring the user information is illustrated in FIG. 3. In FIG. 3, the user is asked questions regarding “a getting on/off operation at the parking lot”, “a parking skill”, and “equipment at and around the parking lot”. The user checks corresponding items and responds to the moving assist device 2.

The route calculation unit 23 illustrated in FIG. 2 calculates a route from a place of departure to a destination. A method of setting the place of departure and the destination is not particularly limited, a user may input the place of departure and the destination, or a GPS may be used to register position coordinates of the user as the place of departure, for example. The route calculated by the route calculation unit 23 is a composite route that includes the parking lot as an intermediate point and includes a vehicle route that indicates moving using a vehicle and a wheelchair route that indicates moving using a wheelchair. In other words, moving of the user in the embodiment includes both moving using the vehicle and moving using the wheelchair. The composite route includes, for example a case (α) in which a route from the place of departure to the parking lot corresponds to the vehicle route, and a route from the parking lot to the destination corresponds to the wheelchair route, a case (β) in which the route from the place of departure to the parking lot corresponds to the wheelchair route, and the route from the parking lot to the destination corresponds to the vehicle route, a case (γ) in which a route from the place of departure to a first parking lot corresponds to the wheelchair route, a route from the first parking lot to a second parking lot corresponds to the vehicle route, and a route from the second parking lot to the destination corresponds to the wheelchair route, and the like.

A method in which the route calculation unit 23 calculates the composite route is not particularly limited, and the composite route can be calculated using various methods. For example, the route calculation unit 23 calculates the composite route with reference to the roadway DB 11, the parking lot DB 12, and the sidewalk DB 13. Here, an example of route calculation processing will be described with reference to the case (α) in which the route from the place of departure to the parking lot corresponds to the vehicle route, and the route from the parking lot to the destination corresponds to the wheelchair route, as an example.

The route calculation unit 23 detects a parking lot near the destination first and calculates each of the vehicle route from the place of departure to the parking lot and the wheelchair route from the parking lot to the destination, for example. “Near the parking lot” means a range in which the wheelchair can move, for example, and the range may be different for each user. In this case, the route calculation unit 23 calculates a plurality of vehicle routes in an order from the shortest time required. Also, the route calculation unit 23 similarly calculates a plurality of wheelchair routes in an order from the shortest time required. Then, the route calculation unit 23 obtains, as composite routes, routes as combinations of the calculated vehicle routes and wheelchair routes. In a case in which a plurality of parking lots are present near the destination, the processing is performed for all the parking lots.

The parking lot barrier determination unit 24 determines whether or not objects, times, or actions that may be parking lot barriers for the user are present in the parking lot. The determination is performed for each parking lot that is present near the destination, for example. The parking lot barrier determination unit 24 determines whether or not objects, times, or actions that may be parking lot barriers are present in the parking lot on the basis of the parking lot specification information (the parking lot running information may also be added) stored in the parking lot DB 12 and the parking lot utilization status information stored in the user information DB 15. There is also a case in which a plurality of parking lot barriers are present in one parking lot, and all the parking lot barriers are specified in that case. The parking lot barrier determination unit 24 associates the specified parking lot barriers with the parking lot.

In a case in which the user answered (checked) that the user “wants to use a rear slope” in the survey illustrated in FIG. 3 while the parking lot does not have such a specification, for example, the specification of the parking lot is a parking lot barrier for the user. Also, in a case in which the user does not answer (does not check) that the user “can do parallel parking” in the survey illustrated in FIG. 3, and the parking lot does not have such a specification, the specification of the parking lot is a parking lot barrier for the user. Also, in a case in which the user answered (checked) that the user “wants to use an elevator” in the survey illustrated in FIG. 3, and the parking lot does not have such a specification, the specification of the parking lot is a parking lot barrier for the user. Also, a time during which the elevator can be used is limited, and the elevator cannot be used in a time period in which the user actually moves to and uses the parking lot, for example, such running of the parking lot is a parking lot barrier for the user. The case where the time during which the elevator can be used is limited includes, for example, a case in which the parking lot is integral with another facility (for example, a station or a large-scaled commercial facility) and a management company that manages the parking lot and a management company that manages the elevator are different for a reason that the elevator is connected to another facility or the like. In such a case, it is assumed that the parking lot is operated for 24 hours while the elevator does not run for 24 hours, for example, and the wheelchair user can use the parking lot only in a time period during which the elevator is running.

The road barrier determination unit 25 determines whether or not road barriers are present along the wheelchair route. The determination is performed for the wheelchair route calculated by the route calculation unit 23, for example. The road barrier determination unit 25 determines whether or not road barriers are present along the wheelchair route with reference to road barrier information stored in the barrier information DB 16. The road barrier determination unit 25 associates the specified road barriers with the wheelchair route.

The route evaluation unit 26 evaluates a route on the basis of barriers included in the route. Here, a composite route that includes a vehicle route that indicates moving using a vehicle and a wheelchair route that indicates moving using a wheelchair is assumed as a route to be evaluated. Therefore, the route evaluation unit 26 evaluates the composite route on the basis of parking lot barriers associated with the parking lot that is an intermediate point of the composite route and road barriers associated with the wheelchair route.

The route evaluation unit 26 scores the parking lot barriers and the road barriers on the basis of some criteria, for example, and evaluates the route on the basis of a total score of the entire composite route. The criteria for scoring the parking lot barriers and the road barriers may be physical criteria or may be preference of the user. The physical criteria include, for example, how high level differences are and the number of level differences, how strong vibration is and a distance by which the vibration continues, how wide the width of a sidewalk is, and the like for the road barriers and include how wide a parking space is and the like for the parking lot barriers. The criteria based on the preference of the user include, for example, a demand that the user does not want to pass through level differences if possible, a demand that the user prefers vibration that is not strong if possible, and the like for the road barriers and a demand that the user definitely needs an elevator and the like for the parking lot barriers. Also, these two kinds of criteria may be combined, and weights in accordance with preference (importance) of the user may be applied to barriers that have been scored on the basis of the physical criteria. Note that, the route evaluation unit 26 may count the number of parking lot barriers and road barriers and may evaluate the route in accordance with the counted number.

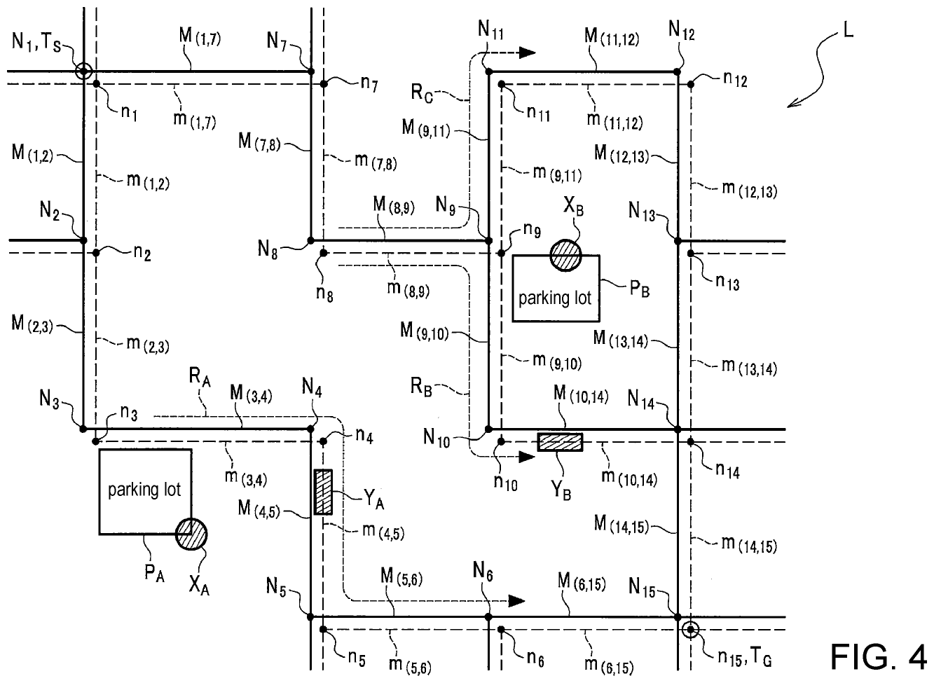

A specific example of the processing of evaluating a route performed by the route evaluation unit 26 will be described with reference to FIG. 4. FIG. 4 is an image diagram schematically illustrating a road map. A road map L illustrated in FIG. 4 includes a roadway network (represented by the solid line) obtained by representing connection of roadways as data and a sidewalk network (represented by the dashed line) obtained by representing connection of sidewalks as data.

The roadway network is configured of a plurality of nodes N (the subscripts are information for identifying nodes and are represented as nodes N₁ to N₁₅ in FIG. 4) set as references (for example, centers in width directions) of roadways and links M (the subscripts are information for identifying links and are represented as links M_{(1, 2)} to M_{(14, 15)} in FIG. 4) that connects the nodes N.

The sidewalk network is configured of a plurality of nodes n (the subscripts are information for identifying nodes and are represented as nodes n₁ to n₁₅ in FIG. 4) set as references of sidewalks and links m (the subscripts are information for identifying links and are represented as links m(1, 2) to m(14, 15) in FIG. 4) that connects the nodes n.

Here, roads including sidewalks provided along roadways and roads including sidewalks that are not distinguished from roadways are assumed. Therefore, the links M of the roadways and the links m of the sidewalks are provided in an aligned manner in FIG. 4. However, the links m of the sidewalks are not aligned with the links M that indicate roads through which only vehicles can pass, such as exclusive roads for vehicles, and the links M of the roadways are not aligned with the links m that indicate roads through which only pedestrians can pass, such as exclusive roads for pedestrians.

In the road map L illustrated in FIG. 4, two parking lots P_{A} and P_{B} are present. The parking lot P_{A} is located near nodes N₃ and n₃ while the parking lot P_{B} is located near nodes N₉ and n₉. A parking lot barrier XA is present in the parking lot P_{A} while a parking lot barrier XB is present in the parking lot P_{B}. Also, a road barrier Y_{A} is present in a link m_{(4, 5)} of the sidewalk while a road barrier Y_{B} is present in a link m_{(10, 14)} of the sidewalk in the road map L. Also, sidewalk barriers caused by vibration (hereinafter, referred to as road barriers S_{(1, 2)} to S_{(14, 15)}) are present in the links m_{(1, 2)} to m_{(14, 15)} of the respective sidewalks although not illustrated. The road barriers S_{(1, 2)} to S_{(14, 15)} are obtained by scoring average values of vibration at the respective links m_{(1, 2)} to m_{(14, 15)} on the basis of a threshold value.

Here, a case in which a route from the node N₁ as a place of departure T_{S} to the node n₁₅ as a destination T_{G} via the parking lots P_{A} and P_{B} as relay points is evaluated will be assumed. Along the route in this case, the following three routes R_{A}, R_{B}, and R_{C} are present.

The route R_{A} is a route of passing through the node N₁ (place of departure T_{S})→the node N₂→the node N₃→the parking lot P_{A}→the node n₃→the node n₄→the node n₅→the node n₆→the node n₁₅ (destination T_{G}) in this order.

The route R_{B} is a route of passing through the node N₁ (place of departure T_{S})→the node N₇→the node N_{S}→the node N₉→the parking lot P_{B}→the node n→the node n₁₀→the node n₁₄→the node n₁₅(destination T_{G}) in this order.

The route R_{C} is a route of passing through the node N₁ (place of departure T_{S})→the node N₇→the node N_{S}→the node N₉→the parking lot P_{B}→the node n₉→the node n₁₁→the node n₁₂→the node n₁₃→the node n₁₄→the node n₁₅(destination T_{G}) in this order.

In this case, the total scores of the routes R_{A}, R_{B}, and R_{C} are as follows, for example.

The total score of the route R_{A} is obtained as “the score of the parking lot barrier X_{A}+the score of the road barrier Y_{A}+the scores of the road barrier S_{(3, 4)} to the road barrier S_{(6, 15)} caused by vibration+others (obtained by scoring the distance of the walking route, for example)”.

The total score of the route R_{B} is obtained as “the score of the parking lot barrier X_{B}+the score of the road barrier Y_{B}+the scores of the road barrier S_{(9, 10)} to the road barrier S_{(14, 15)} caused by vibration+others (obtained by scoring the distance of the walking route, for example)”.

The total score of the route R_{C} is obtained as ‘the score of the parking lot barrier X_{B}+the scores of the road barrier S_{(9, 10)} to the road barrier S_{(14, 15)} caused by vibration+others (obtained by scoring the distance of the walking route, for example).

The route evaluation unit 26 evaluates the respective routes on the basis of such total scores.

The map generation unit 27 generates an assist map obtained by displaying a recommended route based on the evaluation performed by the route evaluation unit 26 on a map, It is preferable to display a plurality of routes (recommended routes) on the assist map in an order from the highest evaluation result (in an order from the smallest total score). Also, it is preferable to display information related to barriers (for example, images or warning sentences with which barriers can be recognized) at locations where the barriers are present on the assist map. In addition, it is preferable to display icons indicating parking lots at locations where the parking lots are present, and operation statuses of the parking lots may be further displayed with the icons. The assist map generated by the map generation unit 27 is transmitted to the user terminal 3 via the communication control unit 21 and is displayed on a display unit provided in the user terminal 3.

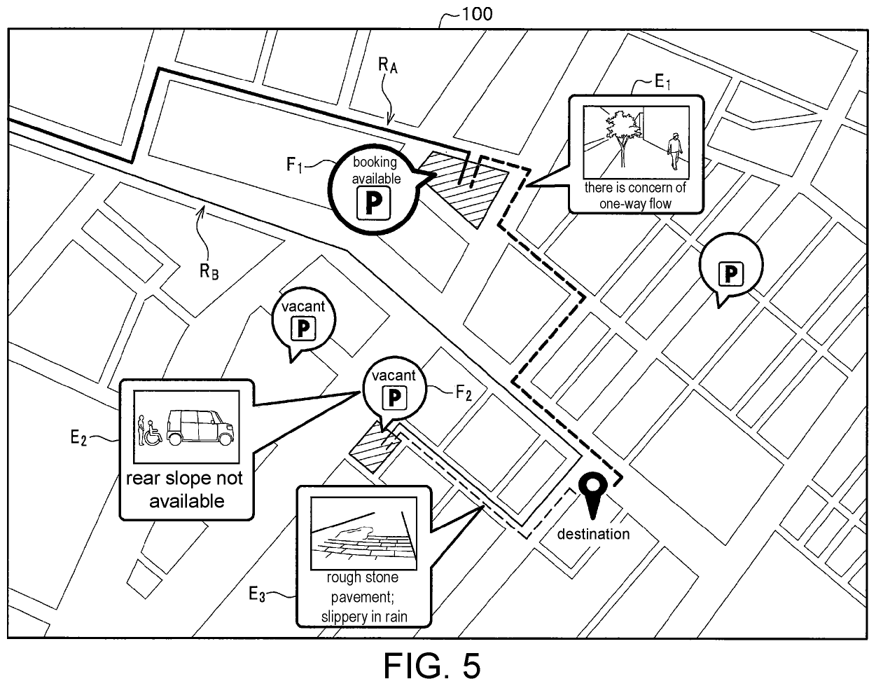

An example of the assist map generated by the map generation unit 27 is illustrated in FIG. 5. In an assist map 100 illustrated in FIG. 5, two routes R_{A} and R_{B} are displayed. One road barrier Y is present along the route R_{A} represented by the thick line, and an image E₁ indicating the road barrier Y is displayed. Also, one parking lot barrier X and one road barrier Y are present along the route R_{B} represented by the thin line, and an image E₂ indicating the parking lot barrier X and an image E₃ indicating the road barrier Y are displayed. Therefore, an evaluation result of the route RA is higher than that of the route RB regardless of the fact that the position of the parking lot is further from the destination as compared with that in the case of the route RB. The map generation unit 27 may display the routes in an emphasized manner in accordance with the evaluation (for example, routes with high evaluation results may be displayed in an easily recognizable manner). The user recognizes the evaluation of the routes and the presence of the barriers that are displayed on the assist map 100 and selects a route suitable for the user himself/herself.

Note that, the map generation unit 27 may display a route based on a past record in addition to or instead of the display of the routes based on the total scores described hitherto. For example, the map generation unit 2 may display a route with a record that the user passed therethrough in the past with priority (or in an emphasized manner) with reference to the action history DB 17. Note that, in a case in which a plurality of routes with records that the user passed therethrough in the past are present, it is preferable to display the latest route or a route with the highest evaluation from the user, for example, with priority. Also, a route with a record that another passed therethrough in the past may similarly be displayed with priority (or in an emphasized manner) with reference to the passing record DB 14.

The parking lot booking processing unit 28 illustrated in FIG. 2 can communicate with the parking lot booking system 4 (see FIG. 1) that manages the parking lots and books a parking lot via the parking lot booking system 4 in response to an instruction from the user. In a case in which the parking lot booking processing unit 28 detects inputs (touching, for example) to icons F1 and F2 for parking lots displayed on the assist map 100 (see FIG. 5), the parking lot booking processing unit 28 transmits a request for booking the parking lots corresponding to the icons F1 and F2 to the parking lot booking system 4. In this manner, the user can easily book a parking lot with recognition of the presence of the parking lot barrier X.

<Operations of Moving Assist System>

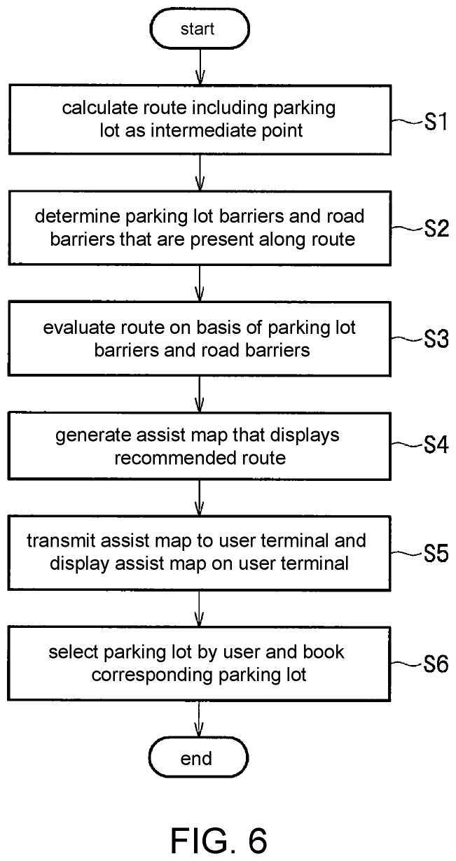

Next, operations of the moving assist system 1 according to the embodiment will be described with reference to FIG. 6 (appropriately referring to FIGS. 1 to 5). FIG. 6 is an example of a flowchart illustrating operations of the moving assist system 6 according to the embodiment. Here, the moving assist device 2 registers parking lot utilization status information in the user information DB 15 in advance by the user answering the survey illustrated in FIG. 3 in advance. Also, the moving assist device 2 appropriately collects road barrier information from the mobile body 5 and registers the collected road barrier information in the barrier information DB 16.

If the moving assist device 2 receives a request for assisting moving to a destination, then the route calculation unit 23 calculates composite routes that include arbitrary parking lots as intermediate points and include vehicle routes that indicate moving using a vehicle and wheelchair routes that indicate moving using a wheelchair (Step S1). The arbitrary parking lots are parking lots near the destination, for example.

Next, the parking lot barrier determination unit 24 determines whether or not objects, times, or actions that may be parking lot barriers for the user are present in the parking lots that are the intermediate points (Step S2). Also, the road barrier determination unit 25 determines whether or not road barriers are present along the wheelchair routes (Step S2). The parking lot barriers and the road barriers, the presence of which has been specified, are associated with the calculated routes.

Next, the route evaluation unit 26 evaluates the route on the basis of the parking lot barriers associated with the parking lots that are the intermediate points in the calculated routes and the road barriers associated with the wheelchair routes (Step S3). The route evaluation unit 26 scores the parking lot barriers and the road barriers on the basis of predetermined criteria, for example, and evaluates the routes on the basis of total scores of the entire composite routes.

Next, the map generation unit 27 sets a plurality of routes with high evaluation results obtained by the route evaluation unit 26 as recommended routes and generates the assist map 100 (see FIG. 5) on which the recommended routes are displayed (Step S4). On the assist map, information related to barriers (for example, images or warning sentences with which the barriers can be recognized) are associated with locations where the barriers are present, and information related to parking lots (for example, icons) are associated with locations where the parking lots are present.

Next, the communication control unit 21 transmits the generated assist map 100 (see FIG. 5) to the user terminal 3, and the user terminal 3 displays the received assist map 100 (Step S5). Then, the user selects a parking lot, and the parking lot booking processing unit 28 books the parking lot selected via the parking lot booking system 4 (see FIG. 1) that manages parking lots (Step S6). Then, the moving assist device 2 starts guidance based on the selected route, and the user moves in accordance with the guidance.

Note that, the routes that include the arbitrary parking lots as the intermediate points are calculated in Step S1, and the barriers included in the calculated route are determined in Step S2. However, the order of the processing is not limited to that described herein. For example, presence of barriers may be specified first, and routes may be calculated on the basis of the specified barriers (for example, routes with a small number of barriers are calculated).

The moving assist system 1 and the moving assist device 2 according to the embodiment are basically configured as described above. Next, effects and advantages of the moving assist system 1 and the moving assist device 2 will be described.

As illustrated in FIG. 2, the moving assist device 2 according to the embodiment is a device that assists a wheelchair user to move. The moving assist device 2 includes the route calculation unit 23 that calculates routes from a place of departure to a destination, the route evaluation unit 26 that evaluates the routes on the basis of barriers included in the routes, and the map generation unit 27 that generates an assist map obtained by displaying recommended routes based on the evaluation on a map. The routes described here are composite routes that include parking lots as intermediate points and include vehicle routes that indicate moving using a vehicle and wheelchair routes that indicate moving using a wheelchair, and the barriers include parking lot barriers related to the parking lots and road barriers related to the wheelchair routes. The parking lot barriers include, for example, narrow parking spaces, no elevator in the parking lots, time periods during which elevators in parking lots do not run, and the like. The road barriers include, for example, level differences, inclinations, uneven road surfaces, and the like. In addition, the route evaluation unit 26 evaluates the composite routes on the basis of the parking lot barriers and the road barriers. As a result, it is possible to present routes that include no (or a minimum of) objects, times, or actions that may obstruct the user in the parking lots and along the roads as recommended routes. Therefore, it is possible to improve convenience for wheelchair users.

Also, the route evaluation unit 26 scores the parking lot barriers and the road barriers and evaluates the composite routes on the basis of total scores of the composite routes. Criteria for scoring the parking lot barriers and the road barriers may be physical criteria or may be criteria based on preference of the user. Also, these two kinds of criteria may be combined, and weights in accordance with preference (importance) of the user may be applied to the barriers that have been scored on the basis of the physical criteria. In this manner, it is possible to more precisely evaluate the parking lot barriers and the road barriers and thereby to present routes that are more suitable for the user.

Also, the road barriers include vibration caused in a case of passing through the wheelchair routes, and the route evaluation unit 26 scores the road barriers related to the vibration on the basis of at least either the strength of the vibration and the distance by which the vibration continues and evaluates the composite routes on the basis of total scores including the scores for the vibration. In this manner, it is possible to include, in the evaluation of the routes, vibration that is unlikely to obstruct pedestrians to pass therethrough but may obstruct wheelchair users to pass therethrough. Therefore, it is possible to present routes that are more suitable for the user.

Also, the moving assist device 2 according to the embodiment further includes the storage unit 10 and the parking lot barrier determination unit 24. The storage unit 10 stores the parking lot specification information related to specifications of parking lots and parking lot utilization status information related to utilization statuses of the parking lots. The parking lot barrier determination unit 24 determines whether or not objects or actions that may be parking lot barriers for the user who is involved in moving of the wheelchair user are present, on the basis of the parking lot specification information and the parking lot utilization status information. The parking lot utilization status information includes at least one of information related to an operation of getting in and out of the wheelchair, information related to a parking skill, and information related to demands for equipment of the parking lots. In this manner, it is possible to evaluate the parking lot barriers in accordance with preference of the user and thereby to present routes that are more suitable for the user.

Also, the moving assist device 2 according to the embodiment may further include the parking lot booking processing unit 28 that can communicate with the parking lot booking system 4 (see FIG. 1) that manages parking lots, and the map generation unit 27 may display icons F1 and F2 indicating parking lots on the recommended routes as illustrated in FIG. 5. In a case in which the parking lot booking processing unit 28 detects inputs to the icons F1 and F2, then the parking lot booking processing unit 28 transmits a request for booking the parking lots corresponding to the icons F1 and F2 to the parking lot booking system 4. In this manner, the user can easily book a parking lot on the route.

Although the embodiment of the disclosure has been described above, the disclosure is not limited to the embodiment and can be implemented in various forms.

In the embodiment, the evaluation of routes has been described with reference to the case (α) in which the route from the place of departure to the parking lot corresponds to the vehicle route and the route from the parking lot to the destination corresponds to the wheelchair route as an example. However, routes can be similarly evaluated for the case (β) in which the route from the place of departure to the parking lot corresponds to the wheelchair route and the route from the parking lot to the destination corresponds to the vehicle route, the case (γ) in which the route from the place of departure to the first parking lot corresponds to the wheelchair route, the route from the first parking lot to the second parking lot corresponds to the vehicle route, and the route from the second parking lot to the destination corresponds to the wheelchair route, and the like.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A moving assist device that assists a wheelchair user to move, the moving assist device comprising:
a route calculation unit that calculates a route from a place of departure to a destination;
a route evaluation unit that perform an evaluation of the route on a basis of barriers included in the route; and
a map generation unit that generates an assist map obtained by displaying a recommended route based on the evaluation on a map,
wherein
the route is a composite route that includes a parking lot as an intermediate point and includes a vehicle route that indicates moving using a vehicle and a wheelchair route that indicates moving using a wheelchair,
the barriers include parking lot barriers related to the parking lot and road barriers related to the wheelchair route, and
the route evaluation unit evaluates the composite route on a basis of the parking lot barriers and the road barriers.

2. The moving assist device according to claim 1, wherein
the route evaluation unit scores the parking lot barriers and the road barriers, and evaluates the composite route on a basis of a total score of the composite route.

3. The moving assist device according to claim 2, wherein
the road barriers include a vibration generated during passing through the wheelchair route, and
the route evaluation unit scores the road barrier related to the vibration on a basis of at least either a strength of the vibration and a distance by which the vibration continues, and evaluates the composite route on a basis of the total score including a score for the vibration.

4. The moving assist device according to claim 1, further comprising:
a storage unit that stores a parking lot specification information related to a specification of the parking lot and a parking lot utilization status information related to a utilization status of the parking lot; and
a parking lot barrier determination unit that determines whether or not an object or an action with a probability of becoming the parking lot barrier for a user involved in moving of the wheelchair user is present, on a basis of the parking lot specification information and the parking lot utilization status information,
wherein the parking lot utilization status information includes at least one of information related to a getting-on/off operation of the wheelchair, information related to a parking skill, and information related to a demand for equipment of the parking lot.

5. The moving assist device according to claim 2, further comprising:
a storage unit that stores a parking lot specification information related to a specification of the parking lot and a parking lot utilization status information related to a utilization status of the parking lot; and
a parking lot barrier determination unit that determines whether or not an object or an action with a probability of becoming the parking lot barrier for a user involved in moving of the wheelchair user is present, on a basis of the parking lot specification information and the parking lot utilization status information,
wherein the parking lot utilization status information includes at least one of information related to a getting-on/off operation of the wheelchair, information related to a parking skill, and information related to a demand for equipment of the parking lot.

6. The moving assist device according to claim 3, further comprising:
a storage unit that stores a parking lot specification information related to a specification of the parking lot and a parking lot utilization status information related to a utilization status of the parking lot; and
a parking lot barrier determination unit that determines whether or not an object or an action with a probability of becoming the parking lot barrier for a user involved in moving of the wheelchair user is present, on a basis of the parking lot specification information and the parking lot utilization status information,
wherein the parking lot utilization status information includes at least one of information related to a getting-on/off operation of the wheelchair, information related to a parking skill, and information related to a demand for equipment of the parking lot.

7. The moving assist device according to claim 1, further comprising:
a parking lot booking processing unit that is able to communicate with a parking lot booking system that manages the parking lot,
wherein the map generation unit displays an icon that indicates the parking lot on the recommended route, and
the parking lot booking processing unit transmits a booking request for a parking lot corresponding to the icon to the parking lot booking system in a case in which the parking lot booking processing unit detects an input to the icon.

8. The moving assist device according to claim 2, further comprising:
a parking lot booking processing unit that is able to communicate with a parking lot booking system that manages the parking lot,
wherein the map generation unit displays an icon that indicates the parking lot on the recommended route, and
the parking lot booking processing unit transmits a booking request for a parking lot corresponding to the icon to the parking lot booking system in a case in which the parking lot booking processing unit detects an input to the icon.

9. The moving assist device according to claim 3, further comprising:
a parking lot booking processing unit that is able to communicate with a parking lot booking system that manages the parking lot,
wherein the map generation unit displays an icon that indicates the parking lot on the recommended route, and
the parking lot booking processing unit transmits a booking request for a parking lot corresponding to the icon to the parking lot booking system in a case in which the parking lot booking processing unit detects an input to the icon.

10. The moving assist device according to claim 4, further comprising:
a parking lot booking processing unit that is able to communicate with a parking lot booking system that manages the parking lot,
wherein the map generation unit displays an icon that indicates the parking lot on the recommended route, and
the parking lot booking processing unit transmits a booking request for a parking lot corresponding to the icon to the parking lot booking system in a case in which the parking lot booking processing unit detects an input to the icon.

11. The moving assist device according to claim 5, further comprising:
a parking lot booking processing unit that is able to communicate with a parking lot booking system that manages the parking lot,
wherein the map generation unit displays an icon that indicates the parking lot on the recommended route, and
the parking lot booking processing unit transmits a booking request for a parking lot corresponding to the icon to the parking lot booking system in a case in which the parking lot booking processing unit detects an input to the icon.

12. The moving assist device according to claim 6, further comprising:
a parking lot booking processing unit that is able to communicate with a parking lot booking system that manages the parking lot,
wherein the map generation unit displays an icon that indicates the parking lot on the recommended route, and
the parking lot booking processing unit transmits a booking request for a parking lot corresponding to the icon to the parking lot booking system in a case in which the parking lot booking processing unit detects an input to the icon.

13. A moving assist system comprising:
the moving assist device according to claim 1; and
a user terminal that includes a display unit for displaying the assist map.

14. A moving assist system comprising:
the moving assist device according to claim 2; and
a user terminal that includes a display unit for displaying the assist map.

15. A moving assist system comprising:
the moving assist device according to claim 3; and
a user terminal that includes a display unit for displaying the assist map.

16. A moving assist system comprising:
the moving assist device according to claim 4; and
a user terminal that includes a display unit for displaying the assist map.

17. A moving assist system comprising:
the moving assist device according to claim 7; and
a user terminal that includes a display unit for displaying the assist map.
